(19) United States
(12) Patent Application Publication
(10) Pub. No.: US 2005/0223833 A1
(43) Pub. Date: Oct. 13, 2005

(54) Transmission with top mounted shift mechanism

(75) Inventors: Gregory A. Ewing, Lee's Summit, MO (US); Donald R. Heskett JR., Centerview, MO (US); Michael A. Van Haele, Blue Springs, MO (US); Thomas L. Buzze, Maiden, NC (US); Ivan E. Bounds, Lake Havasu City, AZ (US)

Correspondence Address: Richard R. Johnson;SHOOK, HARDY & BACON L.L.P., One Kansas City Place, 1200 Main Street, Kansas City, MO, 64105-2118, US

(73) Assignee: Herzog Contracting Corp.

(21) Appl. No.: 10/813,755

(22) Filed: Mar. 31, 2004

(51) Int. Cl. F16H 59/00

(52) U.S. Cl. 74/473.1; 74/473.25; 74/473.36

(57) ABSTRACT

A transmission for a race car or other high performance vehicle includes a top mounted shift lever which has a remote location displaced rearwardly from the standard position directly above the gearbox. The shift lever can be mounted to either side of the gearbox to provide sufficient room and allowing the driver to be stationed away from the door for enhanced safety at the right side mounting position. A novel interlock mechanism is located in the transmission between the shift forks to provide a more compact arrangement and improved reliability.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

This invention relates generally to vehicular transmissions and more particularly to a transmission having a number of improved features which enhance performance, especially when used in a race car or other high performance vehicle.

### BACKGROUND OF THE INVENTION

In race cars and other vehicles that are equipped with top mounted shift mechanisms, the shift lever has a standard location directly above the gearbox. Although this conventional location of the shift lever is acceptable for some applications and some drivers, it is not always a convenient location. Particularly in a race car or other high performance vehicle, the shift lever is often more conveniently accessible if it is situated behind the gearbox where it can be reached more easily by the driver.

The shift lever in a race car also has a standard position where it is located on the left side of the gearbox. This requires many drivers to be seated close to the left side of the car in order to provide room for the driver to be able to effectively operate the shift lever. However, when the driver is close to the side of the car, he or she is more susceptible to serious injury in the event of an accident. From a safety standpoint, it is desirable for the driver to be as far away from the driver side door as possible, more toward the center where he is better protected. Nevertheless, it remains standard in race cars for the shift lever to be located on the left side of the transmission where the driver must be close to the door in order to have sufficient room to have ready access for operating the shift lever.

Transmissions of various types have been equipped with transmission interlock devices which are intended to prevent the transmission from accidentally slipping from one gear to another. The working parts of these prior interlock mechanisms have been located to the side of the transmission. As a result, the interlock construction involves complications due to the need to connect the side mounted interlock parts with the shift forks that are located near the center of the transmission. This complexity and the need for mechanical linkages between the parts has detracted from the effectiveness and reliability of past interlock devices and has created maintenance problems and led to premature mechanical failures.

### SUMMARY OF THE INVENTION

The present invention is directed to a vehicular transmission that is improved in a number of respects compared to transmissions that have been available in the past, particularly for race car applications and other high performance applications. In particular, the transmission of the present invention is characterized by a remote shift lever that is located behind the transmission even though the shift mechanism is a top mounted unit. The invention is further characterized by a unique construction that allows the shift lever to be mounted either on the left or right side of the gearbox and by a novel interlock mechanism that functions in an improved manner compared to the interlock devices that have been proposed in the past.

It is an important object of the invention to provide a transmission that is constructed in a manner allowing the shift lever to be conveniently located for operation by the driver of the vehicle. In this regard, the present invention provides a top mounted shift mechanism in which the shift lever is displaced from directly above the gearbox to a remote location behind the gearbox where it can be reached and operated more easily by many drivers.

Another important object of the invention is to provide a transmission in which the shift mechanism can be mounted on either the left or right side of the transmission. A right side position of the shift mechanism allows the driver to be situated away from the door toward the center of the car at a safer position. At the same time, the shift lever can be located at a standard position on the left side of the transmission if that location is desired. This feature of the invention greatly enhances the versatility of the transmission with respect to the shift lever location.

A further object of the invention is to provide a transmission in which conversion between left and right side positions of the shift lever can be carried out quickly and easily.

An additional object of the invention is to provide a transmission interlock mechanism that functions effectively and reliably to prevent inadvertent slipping from one gear to another. The interlock mechanism is uniquely constructed in a manner taking advantage of a location between the shift forks to result in a simple and efficient mechanical interlock for the transmission.

Yet another object of the invention is to provide a transmission that has particular application in race cars and other high performance vehicles and yet is constructed in a simple and economical manner.

Other and further objects of the invention, together with the features of novelty appurtenant thereto, will appear in the course of the following description.

### BRIEF DESCRIPTION OF THE SEVERAL VIEWS OF THE DRAWINGS

In the accompanying drawings which form a part of the specification and are to be read in conjunction therewith and in which like reference numerals are used to indicate like parts in the various views:

FIG. 1 is a perspective view of a transmission constructed according to a preferred embodiment of the present invention;

FIG. 2 is a side elevational view of the transmission shown in FIG. 1, with a portion of the gearbox broken away for purposes of illustration;

FIG. 3 is a fragmentary top elevational view of the transmission shown in FIGS. 1 and 2, with the top plate of the gearbox installed for a right side mounting of the shift lever;

FIG. 4 is a top plan view similar to FIG. 3 but showing the top plate of the gearbox installed in an orientation rotated 180° from the orientation of FIG. 3 to accommodate a left side mounting of the shift lever;

FIG. 5 is a perspective view on an enlarged scale of the top plate of the gearbox and associated components of the transmission;

FIG. 6 is a perspective view similar to FIG. 5 with portions broken away to show internal details of the interlock mechanism;

FIG. 7 is a perspective view similar to FIG. 6, with the solid lines showing one of the pivot levers rotated to turn the associated shift fork in a manner to shift the transmission into gear and the broken lines showing a neutral condition of the pivot lever;

FIG. 8 is a bottom plan view of the top plate and related components with the shift forks in the neutral position of the transmission;

FIG. 9 is a bottom plan view similar to FIG. 8, but showing one of the shift forks moved to a position in which the transmission is in gear and particularly showing the rigid bar of the interlock mechanism locking one of the shift forks in the neutral position;

FIG. 10 is a bottom plan view similar to FIG. 9, with the broken lines showing one of the spring loaded bars in a position to releasably retain one of the forks in gear; and

FIG. 11 is an exploded perspective view of the top plate and related components of the transmission.

### DETAILED DESCRIPTION OF THE INVENTION

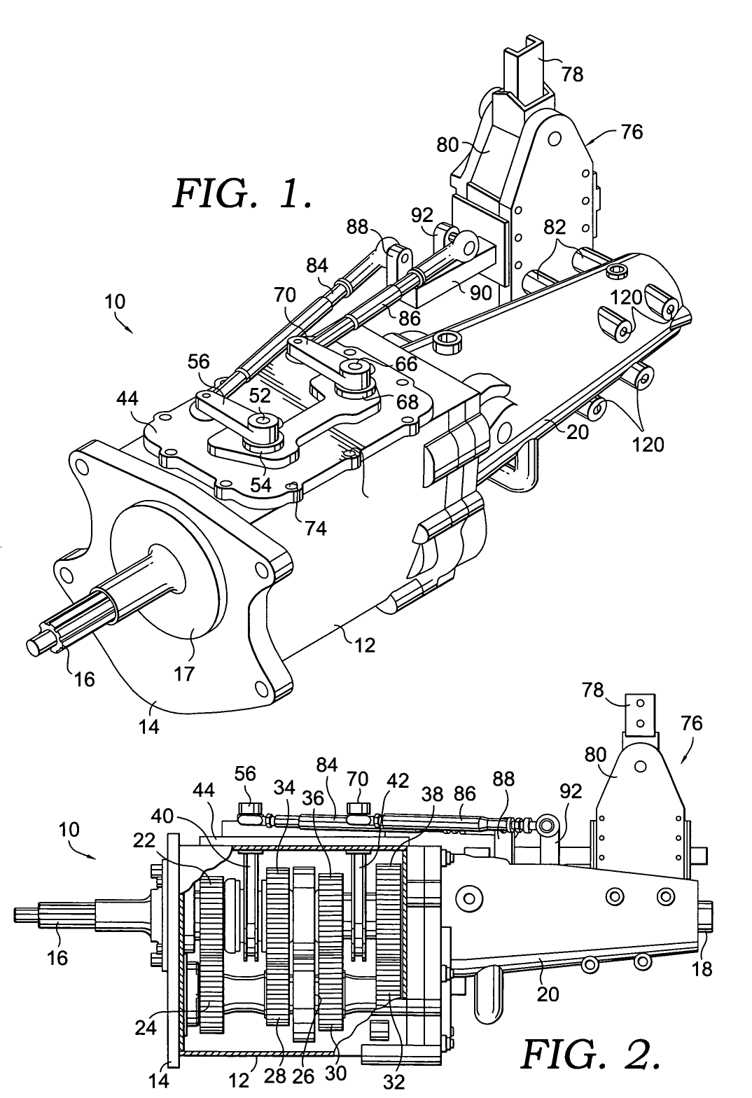

Referring now to the drawings in more detail and initially to FIGS. 1 and 2 in particular, the present invention is directed to a transmission which is generally identified by numeral 10 and which may be used to transmit power in a vehicle such as a race car, another type of high performance vehicle, or virtually any other type of vehicle. The transmission 10 includes a rigid housing or gearbox 12 to which an end plate 14 is bolted or otherwise secured on the front of the gearbox. An input shaft 16 which is driven rotatively by an engine (not shown) extends through the end plate 14 into the gearbox 12 and is supported by a suitable bearing 17. The transmission 10 has an output shaft 18 (FIG. 1) which is axially aligned with the input shaft 16 and extends through an extension or tail piece 20 of the transmission which is bolted or otherwise secured to the end of the gearbox 12 opposite the front end plate 14.

With reference to FIG. 2 in particular, the input shaft 16 carries an input gear 22 at a location within the gearbox 12. The input gear 22 mates with and drives another gear 24 mounted on a countershaft 26 located below and parallel to the input shaft 16 and output shaft 18. The countershaft 26 carries additional gears 28, 30 and 32. Gear 28 mates with and drives a gear 34 that is located on the output shaft 18. Gear 30 similarly drives another gear 36 that is fitted on the output shaft 18, while gear 32 drives another gear 38 on the output shaft.

The transmission is equipped with a pair of shift forks 40 and 42 which serve to selectively engage gears 34, 36 and 38 with the output shaft in order to selectively vary the gear ratio between the input shaft 16 and the output shaft 18. The gearing in the transmission 16 may be conventional and may be of the type described in more detail in pending application Ser. No. 10/292,309, filed on Nov. 12, 2002 in the name of Ewing et al.

In accordance with the present invention, the forks 40 and 42 may be mounted on a flat top plate 44 which in turn may be secured to the top of the gearbox 12 with the forks 40 and 42 located inside of the gearbox at positions straddling the output shaft 18 adjacent to the output shaft gears 34, 36 and 38. As best shown in FIG. 11, each fork 40 and 42 has the shape of an inverted U. A solid cap 46 is mounted on the top center portion of fork 40. A curved arm 48 extends from the cap 46 and presents an arcuate surface 50 that is substantially centered on a vertical pin 52 that extends upwardly from the end of arm 48 opposite the cap 46. The pin 52 extends upwardly through the plate 44 and through a bushing 54 mounted on top of the plate. One end of a pivot link or lever 56 is secured on top of the plate 44 to the upper end of pin 52 in any suitable manner such as by means of a bolt 58.

The other fork 42 has a similar mounting arrangement that is substantially a mirror image of the mounting arrangement for fork 40. A cap 60 is mounted on the top center portion of fork 42 and has an arm 62 extending from it. The arm 62 has an arcuate surface 64 that is substantially centered on an upstanding pin 66 connected with arm 62 at a location offset from the cap 60. Pin 66 extends upwardly through the top plate 44 and a bushing 68 mounted on top of plate 44. One end of a pivot link or lever 70 is secured to the top end of pin 66 at a location above plate 44 by a screw 72 or in any other suitable manner.

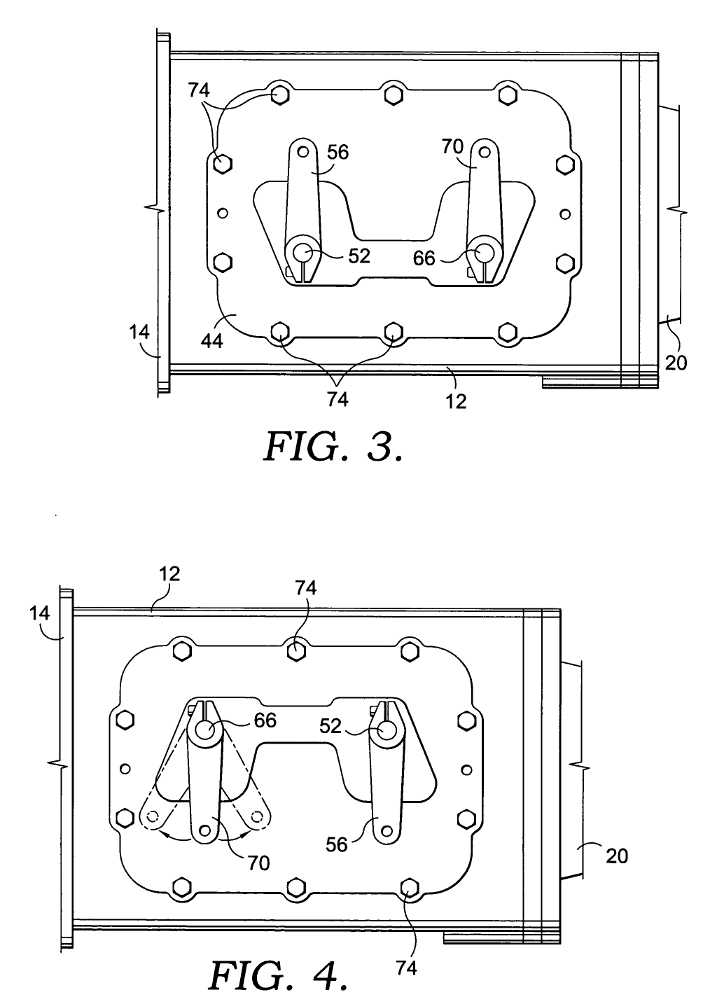

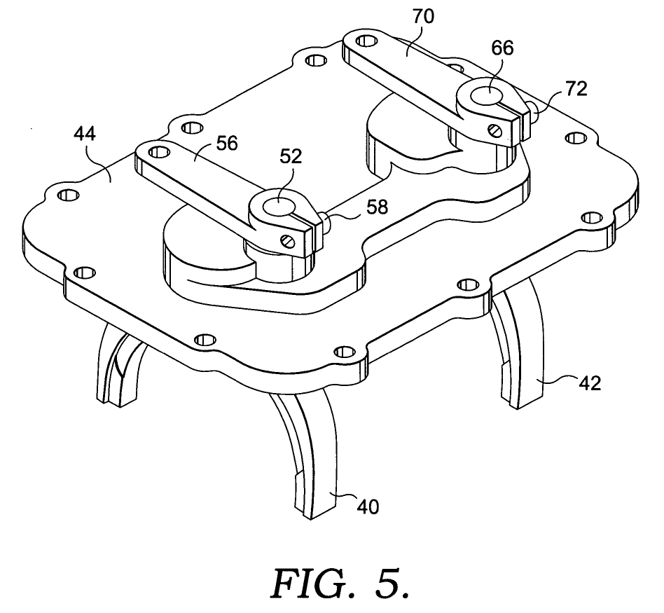

As best shown in FIG. 1, the top plate 44 may be secured on top of the transmission housing or gearbox 12 by bolts 74 or other detachable fasteners. In the position of plate 44 shown in FIGS. 1 and 3, the pivot levers 56 and 70 extend toward the right side of the gearbox 12 from the bushings 54 and 68. The forks 40 and 42 are then positioned within the gearbox 12 as shown in FIG. 2.

With continued reference to FIG. 1 in particular, a shift mechanism which is generally identified by numeral 76 includes a generally vertical shift lever 78 which is shown only fragmentarily in FIG. 1. The shift mechanism includes a rigid housing 80 which may be secured by bolts or other suitable fasteners to a plurality of cylindrical bosses 82 that project from the right side of the tail piece 20. The shift lever 78 extends into the shift mechanism housing 80 and may be moved manually in a manner to operate a shift linkage that includes a pair of rods 84 and 86. One end of rod 84 is pivotally connected with a lug 88 extending upwardly from a bar 90 on the forward end of the shift mechanism housing 80. The opposite end of rod 84 is pivoted to the right or outer end of pivot lever 56. The other rod 86 is similarly pivoted to a lug 92 on bar 90 at one end and to the outer or right end of pivot lever 70 at its opposite end.

The shift mechanism 76 may be conventional and operates in a manner such that when the shift lever 78 is moved between the various gear or shift positions, the rods 84 and 86 are extended or retracted in a manner to pivot the pivot levers 56 and 70 in opposite directions about the axes of the vertical pins 52 and 66. The pivotal movement of the levers 56 and 70 turns the pins 52 and 66 which in turn cranks the forks 40 and 42 in opposite directions, depending upon which direction each of the pins 52 and 66 is rotated by the shift mechanism. The forks 40 and 42 are arranged to engage the output shaft gears 34, 36 and 38 selectively with the output shaft 18 such that each shift position of the shift lever 78 is translated into a pre-selected gear ratio of the gearing within the gearbox 12. Thus, when the shift lever 78 is in a first gear position, the input and output shafts 16 and 18 are connected through the gearing to provide a low condition of the gearing. Selectively higher gear shift positions of the shift lever 78 effect second, third and fourth gear ratios of the transmission in a manner that is well understood in the transmission field. The shift lever 78 has a neutral position in which the forks 40 and 42 are parallel to one another as shown in FIG. 2 and none of the output shaft gears is engaged.

The transmission 10 is provided with an interlock mechanism, the components of which are best shown in FIG. 11. The interlock mechanism includes a pair of relatively short spring loaded bars 94 and 96 which terminate in respective tapered ends 94a and 96a. The bars 94 and 96 are received slidably and closely in a channel 98 which is formed in the plate 44 at a location extending between a pair of openings 100 and 102 that receive the fork assemblies. A compression spring 104 is installed between the two bars 94 and 96 and acts between the bars in a manner constantly urging them outwardly in the channel 98.

The interlock mechanism further includes a solid bar 106 which is tapered on each of its opposite ends. The bar 106 is fit closely yet slidably in channel 98 at a location immediately below the spring loaded bars 94 and 96.

The arcuate surface 50 on arm 48 is provided with a central groove 108 which extends the full height of the surface 50. The groove 108 is a V-shaped groove that conforms generally with the tapered tips of the bars 94, 96 and 106. On opposite sides of the groove 106, the arcuate surface 50 is provided with a pair of V-shaped notches 110. Each notch 110 extends downwardly from the upper edge of surface 50 and terminates at a location below the lower edge of surface 50. Each notch 110 extends downwardly far enough that the tip 94a of bar 94 can enter notch 110 when fork 40 is positioned such that the notch is aligned with the end of the bar. However, the notches 110 terminate at a location high enough that the tip of bar 106 cannot enter either of the notches 110.

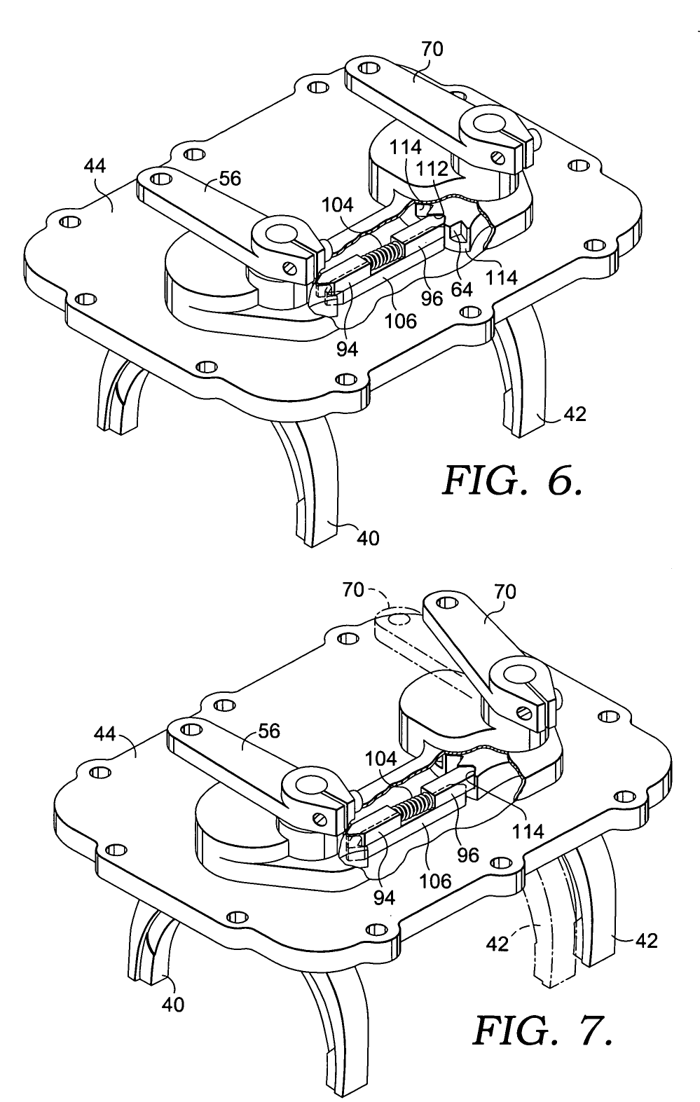

The other arcuate surface 64 is provided with a similar groove and notch arrangement. As particularly shown in FIG. 6, surface 64 has a central V-shaped groove 112 and a pair of V-shaped notches 114 on opposite sides of the groove 112. The groove 112 extends the entire height of the surface 64 such that the tips of bar 96 and bar 106 can enter groove 112 when the groove is aligned with them. The notches 114 extend downwardly into surface 64 and are located such that the tip 96a of bar 96 can enter either of the notches when they are aligned with the bar. However, the notches 114 terminate high enough that the tip of bar 106 cannot enter notches 114.

With reference again to FIG. 11 in particular, the bars 94, 96 and 106 and the spring 104 are retained in channel 98 by a cover plate 116. The cover plate 116 is fitted against the underside of plate 44 at a location to cover the bottom of channel 98 and may be secured by screws 118 or other fasteners.

In operation of the transmission, the shift lever 78 may be shifted to a neutral position in which the shift forks 40 and 42 are located as shown in FIG. 2 with none of the gears 34, 36 or 38 connected with the output shaft 18. The shift lever 78 may also be shifted among the various different gears which provide different gear ratios, with selected gears 34, 36 or 38 (or additional gears on the output shaft if desired) engaged with the output shaft in order to drive it at the selected gear ratio relative to the input shaft 16.

The housing 80 for the shift mechanism may be secured to the right side of the transmission as shown in FIG. 1. The linkages between the shift mechanism and the shift forks 40 and 42 extends on top of the gearbox 12 such that the shift mechanism is at a top mounted position. Additionally, when installed on the right side of the gearbox 12 as shown in FIG. 1, the shift lever 78 is positioned rightwardly far enough that the driver can move well away from the driver side door at a position that minimizes the risk of serious injury in the event of a collision.

The shift mechanism may be installed alternatively on the left side of the transmission. The housing 80 can be detached from the cylindrical bosses 82, and the rods 86 and 84 can be detached so that the housing 80 can be moved to the left side of the transmission and bolted or otherwise secured to bosses 120 that project from the left side of the tail piece 20. The fasteners 74 can be removed to allow the top plate 44 and the components attached to it to be rotated through a 180° arc and installed on top of the gearbox 12 in the rotated position by installing the fasteners 74 again. The pivot levers 56 and 70 then project toward the left side of the gearbox 12, and the rods 84 and 86 can be connected to them to complete the installation. Regardless of which side the shift mechanism is installed, the shift pattern remains the same due to the construction and arrangement of the shift fork assemblies and the levers 56 and 70 and shift mechanism linkage.

In this manner, the shift mechanism can be mounted to either side of the transmission. In either case, the shift lever is at a remote location where it is displaced from directly above the gearbox where standard shift levers on top mounted shift mechanisms are normally located. This positions the shift lever 78 well to the rear at a more convenient location for many drivers.

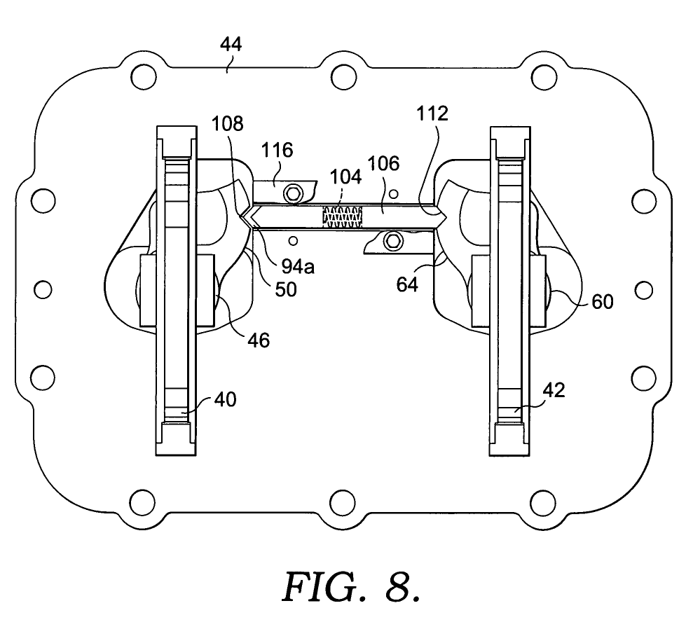

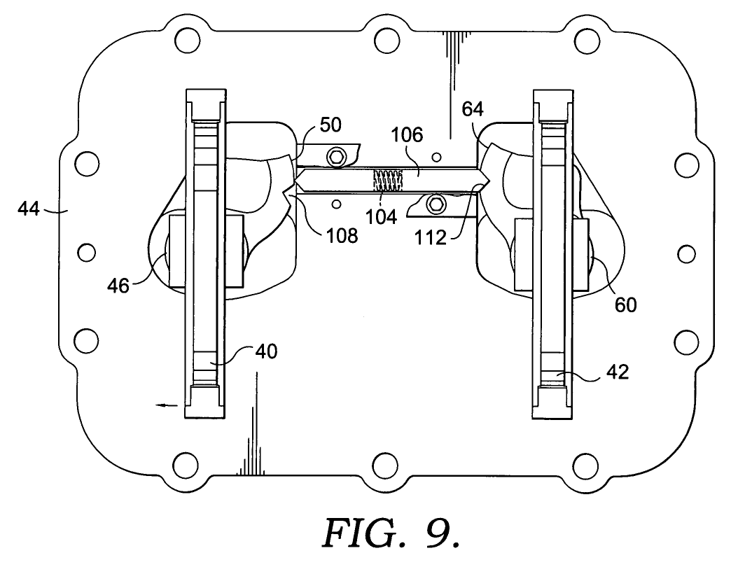

The interlock mechanism operates to prevent accidental slipping of the transmission when it is in gear. When the shift lever 78 is in the neutral position (shown in FIG. 8), the spring loaded bars 94 and 96 and the solid bar 106 are aligned with the two grooves 108 and 112. Due to the spring loading of bars 94 and 96, their tips 94a and 96a enter the respective grooves 108 and 112 (as shown in FIG. 8 for tip 94a). However, the length of bar 106 is such that when one of its tips fully enters the groove 108, the opposite tip is barely out of the groove in the opposite fork assembly. The spring loaded bars thus releasably latch the transmission in the neutral position while allowing it to be shifted into gear as the spring 104 is compressed.

The solid bar 106 allows the transmission to be shifted into gear because both of its tips are not in the opposing grooves 108 and 112. When one of the levers 56 or 70 is turned by shifting the lever 78 into gear, the corresponding fork 40 or 42 is moved to engage one of the drive gears 34, 36 of 38. The transmission is then in the appropriate gear. Once it has reached a gear position, as shown in the solid line position of FIG. 7, for example, one of the spring loaded bars (bar 96 in this case) is pushed into the aligned notch 114 in order to releasably latch the transmission in the gear to which it has been shifted. As the arcuate surface 64 is turned due to actuation of the shift fork 42, the surface 64 acts against the adjacent tip of the solid bar 106 in a camming manner in order to maintain the opposite tip of the bar in the opposing groove 108. Consequently, the opposite fork 40 is locked in position and cannot be activated.

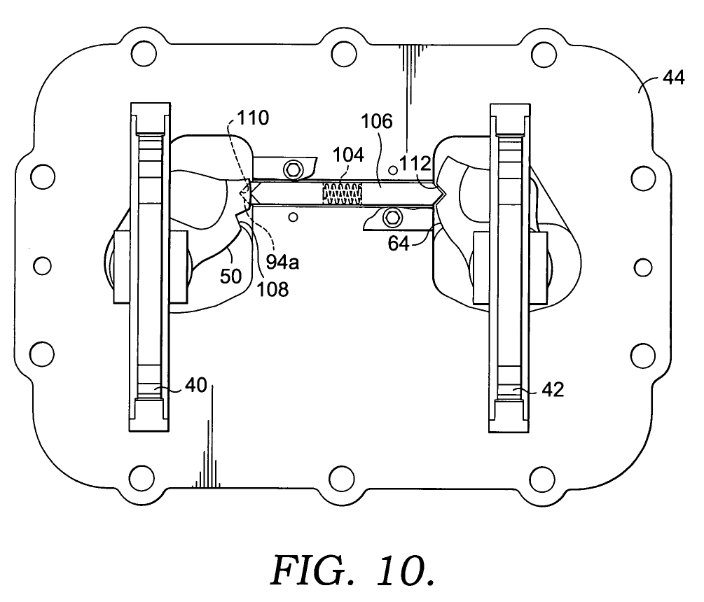

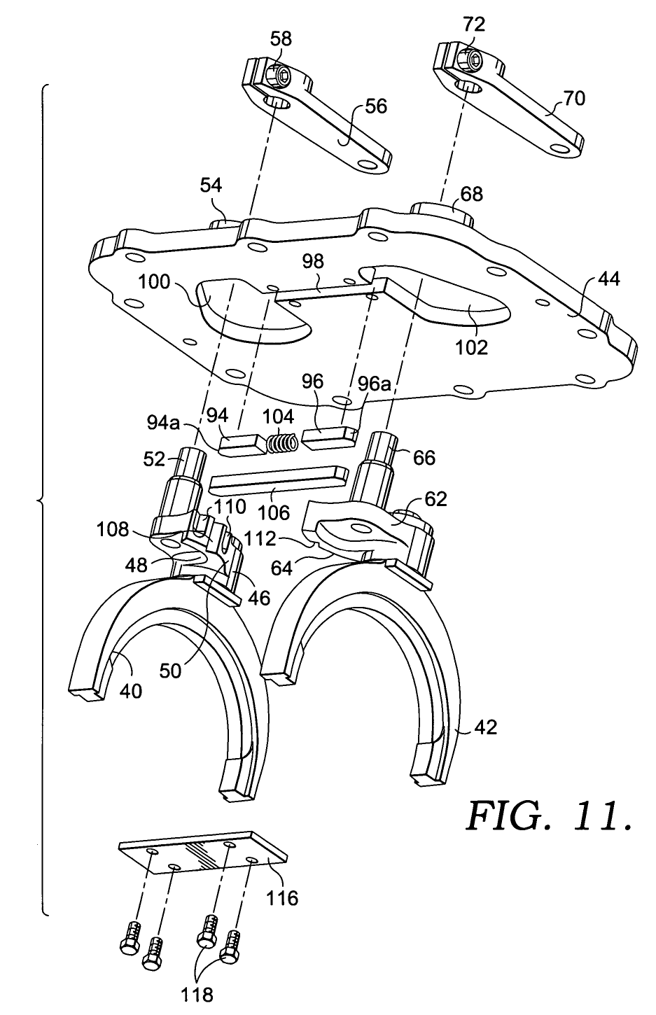

Before fork 40 can be actuated, the shift lever must be moved to the neutral position in order to move fork 42 to a position in which its groove 112 is aligned with bar 106, which is the neutral position. Then, fork 40 can be moved because the tip of bar 106 can enter groove 112 to allow fork 40 to be moved and the arcuate surface 50 to be turned such that a different gear is effected by the transmission. When a gear position is reached, the tip 94a of bar 94 enters one of the grooves 110 (see FIG. 10) in order to releasably latch the transmission in the gear to which it has been shifted. The arcuate surface 50 acts against the adjacent tip of the solid bar 106 and thus maintains the opposite tip of bar 106 in groove 112 to provide the interlock function. Fork 42 can be moved only after the transmission has been shifted again to the neutral position where groove 108 is aligned with bar 106 to allow the bar to move out of groove 112.

In this manner, the interlock mechanism prevents the transmission from inadvertently slipping out of a gear position to which it has been shifted. One of the forks is always in the neutral position, and it cannot be shifted while the other fork is in a gear position.

It is noted that the interlock function is performed in an effective and reliable manner while locating the parts in a compact arrangement in the vicinity of and between the fork assemblies. This location of the interlock components provides a compact structure as well as avoiding complexity, expense and maintenance and reliability problems.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

1. A vehicular transmission comprising:
a gearbox receiving input and output shafts and containing a plurality of gears for connecting the input and output shafts in a plurality of different gear ratios;
at least one shift fork in said gearbox for shifting said gears in a manner to selectively effect said different gear ratios;
a link mounted on top of said gearbox exteriorly thereof for actuating said shift fork when said link is operated;
a manually operated shift lever mounted at a location behind said gearbox for movement between a plurality of shift positions corresponding to pre-selected gear ratios; and
a linkage extending between said shift lever and said link for transmitting movement of said shift lever to said link in a manner to actuate said fork to effect a gear ratio corresponding to the position of the shift lever, said linkage extending on top of and exteriorly of said gearbox.

2. A vehicular transmission comprising:
a gearbox having left and right sides and receiving input and output shafts, said gearbox containing a plurality of gears for connecting the input and output shafts in a plurality of different gear ratios;
a shift lever mechanism having a manually operated shift lever movable between a plurality of shift positions corresponding to pre-selected gear ratios, said shift lever mechanism having a first mounting position on the left side of said gearbox and a second mounting position on the right side of said gearbox; and
a linkage extending between said shift lever mechanism and said gears in both the first and second mounting positions thereof for translating movement of said shift lever between said shift positions into gear ratios corresponding to said shift positions.

3. A vehicular transmission comprising:
a gearbox having left and right sides and receiving input and output shafts, said gearbox containing a plurality of gears for connecting the input and output shafts in a plurality of different gear ratios;
a top plate for said gearbox on which at least one shift fork and one pivot lever are mounted, said shift fork and pivot lever being connected by a pivot shaft which transmits pivoting of said lever into movement of said fork to effect shifting of said gears to effect different gear ratios;
said top plate being applicable to said gearbox in a first orientation wherein said pivot lever extends on top of said gearbox toward the left side thereof and a second orientation wherein said pivot lever extends on top of said gearbox toward the right side thereof, said top plate being rotated approximately 180° from said first orientation to said second orientation;
a manually operated shift lever for effecting shifting of the gears between different gear ratios, said shift lever having alternative positions including a first position generally behind said pivot lever in the first orientation of the top plate and a second position generally behind said pivot lever in the second orientation of the top plate; and
a linkage extending between said shift lever and said pivot lever for transmitting movement of said shift lever into pivotal movement of said pivot lever in a manner to actuate said fork through said pivot shaft to effect a gear ratio corresponding to the position of the shift lever, said linkage being applicable to said shift lever and pivot lever when said top plate is in said first orientation and said shift lever is in said first position, and when said top plate is in said second orientation and said shift lever is in said second position.

4. A vehicular transmission comprising:
a gearbox having left and right sides and receiving input and output shafts, said gearbox containing a plurality of gears for connecting the input and output shafts in a plurality of different gear ratios;
a top plate for said gearbox on which first and second shift forks and first and second pivot levers are mounted, said shift forks and pivot levers being connected by pivot shafts which transmits pivoting of said first lever into movement of said first fork and pivoting of said second lever into movement of said second fork in a manner to effect shifting of said gears to effect different gear ratios;
said top plate being applicable to said gearbox in a first orientation wherein said pivot levers extend on top of said gearbox toward the left side thereof and a second orientation wherein said pivot levers extend on top of said gearbox toward the right side thereof, said top plate being rotated approximately 180° from said first orientation to said second orientation;
a manually operated shift lever for effecting shifting of the gears between different gear ratios, said shift lever having alternative positions including a first position generally behind said pivot levers in the first orientation of the top plate and a second position generally behind said pivot levers in the second orientation of the top plate; and
a linkage extending between said shift levers and said pivot levers for transmitting movement of said shift lever into pivotal movement of said pivot levers in a manner to actuate said forks through said pivot shafts to effect a gear ratio corresponding to the position of the shift lever, said linkage being applicable to said shift lever and said pivot levers when said top plate is in said first orientation and said shift lever is in said first position, and when said top plate is in said second orientation and said shift lever is in said second position.

5. A vehicular transmission comprising:
a gearbox receiving input and output shafts and containing a plurality of gears for connecting said input and output shafts in a plurality of different gear ratios, said gearbox having a neutral condition of said gears;
first and second shift forks in said gearbox each being in a neutral position in the neutral condition of the gears, one of said forks being offset from the neutral position in each of said different gear ratios;
a shift mechanism including a shift lever located behind said gearbox and being manually operable to different shift positions corresponding to said different gear ratios;
a linkage extending between said shift mechanism and said shift forks for transmitting movement of said shift lever to said forks in a manner to effect a gear ratio corresponding to the position of the shift lever, said linkage extending on top of said gearbox; and
an interlock mechanism for locking said first shift fork in the neutral position thereof when said second shift fork is displaced from the neutral position thereof, and for locking said second shift fork in the neutral position thereof when said first shift fork is displaced from the neutral position thereof.

6. A transmission as set forth in claim 5, wherein said linkage extends on top of said gearbox.

7. A transmission as set forth in claim 6, including means for mounting said shift lever alternatively on opposite sides of said gearbox.

8. A transmission as set forth in claim 5, including means for mounting said shift lever alternatively on opposite sides of said gearbox.

9. A transmission as set forth in claim 5, wherein:
said shift forks rotate selectively from the neutral positions thereof to effect said different gear ratios; and
said interlock mechanism is located between said shift forks.

10. A transmission as set forth in claim 9, wherein said interlock mechanism comprises an interlock bar extending between said shift forks and engaging said first fork in a manner locking said first fork in the neutral position thereof when said second shift fork is displaced from the neutral position thereof, and engaging said second fork in a manner locking said second fork in the neutral position thereof when said first shift fork is displaced from the neutral position thereof.

11. A transmission as set forth in claim 10, wherein said interlock mechanism includes:
a first groove in said first shift fork aligned with said interlock bar in the neutral position of said first fork;
a second groove in said second shift fork aligned with said interlock bar in the neutral position of said second fork;
a first camming surface on said first shift fork adjacent to said first groove and acting against said interlock bar in a manner locking said bar in said second groove when said first fork is displaced from the neutral position thereof; and
a second camming surface on said second shift fork adjacent to said second groove and acting against said interlock bar in a manner locking said bar in said first groove when said second shift fork is displaced from the neutral position thereof.

12. A transmission as set forth in claim 11, including:
first and second latch bars located between said shift forks and urged away from one another such that said first latch bar is urged toward said first camming surface and said second latch bar is urged toward said second camming surface;
a first notch in said first camming surface displaced from said first groove at a location aligned with said first latch bar when said first fork is displaced to a first selected gear ratio of said gears, whereby said first latch bar enters said first notch to releasably latch said first fork to maintain said first selected gear ratio;
a second notch in said second camming surface displaced from said second groove at a location aligned with said second latch bar when said second fork is displaced to a second selected gear ratio of said gears, whereby said second latch bar enters said second notch to releaseably latch said second fork to maintain said second selected gear ratio, said first and second notches being situated to avoid entry therein of said interlock bar.

13. A transmission as set forth in claim 12, wherein said interlock bar is mounted slidably to said gearbox at a location adjacent to said first and second latch bars.

14. A transmission as set forth in claim 13, wherein said linkage extends on top of said gearbox.

15. A transmission as set forth in claim 14, including means for mounting said shift lever alternatively on opposite sides of said gearbox.

16. A transmission as set forth in claim 10, wherein said linkage extends on top of said gearbox.

17. A transmission as set forth in claim 16, including means for mounting said shift lever alternatively on opposite sides of said gearbox.

18. A transmission as set forth in claim 10, including means for mounting said shift lever alternatively on opposite sides of said gearbox.

19. A transmission as set forth in claim 13, including means for mounting said shift lever alternatively on opposite sides of said gearbox.
